(19) United States
(12) Patent Application Publication
(10) Pub. No.: US 2025/0024306 A1
(43) Pub. Date: Jan. 16, 2025

(54) Method for determining the movement of a mobile terminal, device and corresponding computer program

(71) Applicant: ORANGE, Issy-les-Moulineaux (FR)

(72) Inventors: Rémy Scholler, CHÂTILLON CEDEX (FR); Denis Renaud, CHÂTILLON CEDEX (FR)

(21) Appl. No.: 18/714,784

(22) PCT Filed: Nov. 23, 2022
(86) PCT No.: PCT/EP2022/083055

§ 371 Date: May 30, 2024

(30) Foreign Application Priority Data
Nov. 30, 2021 (FR) FR2112775

(51) Int. Cl. H04W 28/02; H04L 5/00; H04W 4/029; H04W 64/00

(52) U.S. Cl. CPC H04W 28/0226; H04L 5/0048; H04W 4/029; H04W 64/006

(57) ABSTRACT

There are many techniques for determining the actual movement of a mobile terminal using signalling data. According to these techniques, a position of the mobile terminal is estimated, approximated by the centre of a cell of a base station to which the mobile terminal is connected. To do this, use is made of a Voronoi partitioning of the territory covered by the cells. Each network event is then positioned at the centre of the cell in which it occurs. Such events are time-stamped, enabling a distance travelled to be calculated. However, such techniques have the following limitations specific to Voronoi partitions. This solution goes against these methods, which first require estimating the two positions of the mobile terminal. The present solution helps to overcome this constraint by using a likelihood map of support by a base station support.

### FIELD OF THE INVENTION

The field of the invention is that of the localisation of mobile objects connected to at least one communication network.

More specifically, the invention relates to a method for determining a movement of a mobile terminal by means of the signalling data collected and the corresponding device, computer program and medium.

### PRIOR ART AND ITS DISADVANTAGES

The signalling data collected by a telecommunications operator within the communication network or networks it operates enables it to identify the use made by its users of the resources it makes available to them. Armed with this knowledge, a telecommunications operator can then plan development and maintenance operations for the equipment that makes up the communications networks it operates enabling it to meet the needs and expectations of its users.

In recent years, with the development of the Internet of Things (IoT) and the emergence of connected vehicles, telecommunications operators have realised that the traffic signalling data in their possession could be of interest to other players and that they were thus becoming an asset to value.

Signalling data from mobile terminals used during travelling is of particular interest for the study of human mobility, whether mobile terminals belonging to a user or mobile terminals embedded in a vehicle.

There are many techniques for estimating a situation of mobility of a mobile terminal. One of the various known techniques is used to estimate a situation of mobility of a mobile terminal using signalling data. According to this technique, the position of the mobile terminal is estimated, approximated by the centre of a coverage area, or cell, of a base station to which the mobile terminal is connected. To do this, use is made of a Voronoi partitioning of the territory covered by the cells making up a radio communication network. Each network event is then positioned at the centre of the cell in which it occurs. Such events are time-stamped, enabling a distance travelled by a mobile terminal to be calculated based on the coordinates of the centres of the cells.

However, such a technique has the following limitations specific to Voronoi partitions:
all cells are assumed to be omnidirectional,
the characteristics of the cells (radiation power, height and inclination of the base station antennas) are not taken into account,
the overlap of action zones of the cells is not taken into account,
no location a priori is used.

The cells of a radio communication network sometimes cover large areas, e.g. with a radius of more than 5 km, so the position estimates obtained with such a technique are very uncertain and so are the estimates of a distance travelled by a mobile terminal.

There is therefore a need for a solution that does not have all the above disadvantages for obtaining information representative of a movement of a mobile terminal by means of signalling data.

### SUMMARY OF THE INVENTION

The invention addresses at least partially this need by proposing a method for determining the movement of a mobile terminal.

The present application relates to a method for determining a value of a variable representative of a movement of a mobile terminal.

According to at least one embodiment, the method comprises:
determining a first probability density of a variable representative of a movement of the mobile terminal according to:
   a first likelihood map of support by a first base station with which the mobile terminal interacted during a first network event involving said mobile terminal, and
   a second likelihood map of support by a second base station with which the mobile terminal interacted during a second network event involving said mobile terminal,
obtaining said value of said variable representative of a movement of the mobile terminal from the first probability density of said variable representative of a movement of the mobile terminal and from data representative of a movement of said mobile terminal within a coverage area of a third base station.

According to at least one embodiment, the data representative of a movement of said mobile terminal within a coverage area of said third base station comprises a second probability density of said variable representative of a movement of the mobile terminal, obtained by means of a third likelihood map of support by said third base station with which the mobile terminal interacted during a third network event involving the mobile terminal, and a fourth network event involving the mobile terminal.

According to at least one embodiment, the first, second, third and/or fourth network event is associated respectively with a first, second, third and/or fourth set of signalling data comprising, among others, respectively, an item of timestamp data of said first, second, third and/or fourth network event.

According to at least one embodiment, such a method is particular in that, a network event involving said mobile terminal being associated with a set of signalling data comprising among others an item of timestamp data of the event and a likelihood map of support by a base station with which the mobile terminal interacted during the event, said method comprises:
determining a first density representative of a variable representative of a movement of a terminal by the mobile terminal according to a first likelihood map of support by a base station associated with a first network event involving the mobile terminal, and to a second likelihood map of support by a base station associated with a second network event involving the mobile terminal, obtaining said value of a variable representative of a movement of the mobile terminal from the first density representative of a variable representative of a movement of the mobile terminal and from data representative of a movement of said mobile terminal within a coverage area of a third base station.

In the present application, network event is understood to mean any event giving rise to a transmission or a reception of signalling data between a mobile terminal and a base station of a communications network, such as the establishment of a call between the mobile terminal and the base station, for example in the event of an incoming or outgoing call or in the event of the transmission or reception of a short message or SMS, the triggering of a procedure for attachment to the base station, the transmission of a paging message to the mobile terminal asking it to wake up from a standby state, etc.

Such an approach goes against the conventional approach of determining a value of a distance actually travelled by a mobile terminal from two precise positions of the mobile terminal, which first requires the two positions of the mobile terminal to be estimated.

The present solution helps to overcome this constraint by using a likelihood map of support by a base station support.

Such a likelihood map of support by a base station represents the probability of a mobile terminal connecting to a base station at a location within the coverage area of the base station. Such a likelihood map does not correspond directly to a spatial probability density of the presence of the mobile.

These likelihood maps of support by a base station have the advantage of taking into account the direction of the cells, their radiation characteristics, the overlap of their action zones and use an a priori for locating mobile terminals, contrary to some techniques of the state of the art and more particularly to the techniques using the Voronoi partitions.

In one example, the data representative of a movement of said mobile terminal within a coverage area of a third base station comprises a second density representative of a variable representative of a movement of the mobile terminal obtained by means of a third likelihood map of support by a base station associated with a third network event involving the mobile terminal, and with a fourth network event involving the mobile terminal.

Such a second density of distance travelled represents an uncertainty of movement of the mobile terminal inherent in the radio communication network. In other words, such an item of information can be assimilated to noise.

Thus, the first density of distance travelled by the mobile terminal is compared to this item of noise information in order to determine whether the mobile terminal has actually moved, i.e. has changed its home base station consecutively to an (actual) move, or whether the mobile terminal has not left the coverage area of a base station and is therefore immobile from the point of view of the radio communications network.

In one example, obtaining said value representative of a variable representative of a movement of the mobile terminal comprises a comparison between the first probability density of the variable representative of a movement of the mobile terminal and the second probability density of the variable representative of a movement of the mobile terminal.

In another example, the comparison between the first probability density of the variable representative of a movement of the mobile terminal and the second density representative of the variable representative of a movement of the mobile terminal comprises determining an overlap rate between the first probability density of the variable representative of a movement of the mobile terminal and the second density representative of the variable representative of a movement of the mobile terminal.

In one example, the first event and the second event are selected from a plurality of network events involving the mobile terminal and occurring during a first time window.

This makes it possible to estimate the mobility conditions of terminal over a short time window, for example 15 minutes, which is not the case with a number of techniques in the state of the art, which have difficulty extracting relevant information over short time windows because of their poor recognition of the uncertainties in locating mobile terminals. Moreover, this can make the present solution compatible with a number of legislative provisions relating to the retention of event logs relating to mobile terminals.

In one example, the method comprises at least two iterations of the determining step and further comprises determining an average value of the variable representative of a movement of the mobile terminal by combining the first probability densities of the variable representative of a movement of the mobile terminal determined during each of said iterations.

Increasing the number of pairs of events to be taken into account can help, at least in some embodiments, to improve the accuracy of estimating the value of the distance travelled by the mobile terminal.

In one example, the first event and the second event are temporally spaced by at least one first duration.

An immobile terminal that is in a situation of immobility can sometimes attach itself to a base station that is not the closest to its position. This may be due to various factors: a building located in front of the antennae of the nearest base station hindering the propagation of the signal, an overload on the base station, a window facing a more distant base station making it easier to attach to it, etc.

Very often, this type of base station change or “hand-over” occurs in a short period of time (ranging from a few seconds to a few minutes). An attachment of the mobile terminal to the nearest base station is then observed. This is referred to as a cellular oscillation phenomenon. This phenomenon thus generates a noise inherent in the operation of a radio network.

This cellular oscillation phenomenon can also occur with mobile terminals in a situation of mobility, then a sudden deviation from the global mobile trace of the mobile terminal (sequence of cells over time) can be observed. A cell oscillation corresponds to a slight actual movement, and to a more or less large “hop” at the radio communication network level. If the “hop” at the radio communication network level is small, this has little impact on the observed behaviour of the mobile terminal. On the other hand, if the “hop” is large, it can add “noise” to the observed behaviour of the mobile terminal, and can even give the impression of a false situation of mobility in some cases.

The cellular oscillation phenomenon can therefore make a “hop” seem like an event to be taken into account when estimating the value of a variable representative of a movement of a mobile terminal. This cellular oscillation phenomenon can be frequent and can give rise to highly spread out or offset probability densities for distances towards long distances, resulting in aberrant distance measurements.

To mitigate these effects, the present solution proposes a certain period of time to separate the events constituting a pair of events.

Another way of mitigating the network oscillation phenomenon is to impose a maximum distance between the base stations involved in the events considered. For example, two events that are at least 1,000 km apart can be excluded.

In one example, the variable representative of a movement of a mobile terminal is a movement distance of the mobile terminal.

In another example, the variable representative of a movement of a mobile terminal is a movement direction of the mobile terminal.

According to another aspect, the present application also relates to an electronic device adapted to implement the method of the present application in at least one of its embodiments.

The purpose of the invention is also a device capable of determining a movement of a mobile terminal, for example a device capable of obtaining a value of a distance actually travelled by a mobile terminal.

According to at least one embodiment, said device comprises at least one processor adapted to:
determine a first probability density of a variable representative of a movement of the mobile terminal according to:
   a first likelihood map of support by a first base station with which the mobile terminal interacted during a first network event involving the mobile terminal, and
   a second likelihood map of support by a second base station with which the mobile terminal interacted during a second network event involving the mobile terminal,
obtain said value of said variable representative of a movement of the mobile terminal from the first probability density of said variable representative of a movement of the mobile terminal and from data representative of a movement of said mobile terminal within a coverage area of a third base station.

According to at least one embodiment, such a device is particular in that, a network event involving said mobile terminal being associated with a set of signalling data comprising, among other things, an item of timestamp data of the event and a likelihood map of support by a base station with which the mobile terminal interacted during the event, said device comprises at least one processor adapted to:
determine a first density representative of a variable representative of a movement of a terminal by the mobile terminal according to a first likelihood map of support by a base station associated with a first network event involving the mobile terminal, and to a second likelihood map of support by a base station associated with a second network event involving the mobile terminal,
obtain said value of a variable representative of a movement of the mobile terminal from the first density representative of a variable representative of a movement of the mobile terminal and from data representative of a movement of said mobile terminal within a coverage area of a third base station.

Such a device may, for example, be embedded in a server belonging to the telecoms operator operating the radio communication network to which the base stations belong.

Finally, the invention relates to a computer program product comprising program code instructions for implementing a method as described previously when it is executed by a processor.

The invention also relates to a computer-readable storage medium on which is saved a computer program comprising program code instructions for implementing the steps of the method according to the invention as described above.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely.

The program according to the invention can be downloaded in particular on a network, for example the Internet network.

Alternatively, the storage medium can be an integrated circuit in which the program is embedded, the circuit being adapted to execute or to be used in the execution of the method of the above-mentioned invention.

### LIST OF FIGURES

Other purposes, features and advantages of the invention will become more apparent upon reading the following description, hereby given to serve as an illustrative and non-restrictive example, in relation to the figures, among which:

FIG. 1: this figure shows a diagram of the steps of a method for determining a movement of a mobile terminal in a first example of implementation. In this first example, the variable representative of a movement of the mobile terminal is the movement distance,

FIG. 2A: this figure shows a likelihood map of support by a cell obtained on the assumption of an a priori uniform presence of the mobile,

FIG. 2B: this figure shows a likelihood map of support by a cell obtained on the assumption of an a priori presence of the mobile along a road and a high-speed train line,

FIG. 3: this figure shows the radius of action of an antenna of the corresponding base station, expressed in metres,

FIG. 4A: this figure shows a situation in which the mobile terminal is stationary from the point of view of the radio communications network,

FIG. 4B: this figure shows a situation in which the mobile terminal is mobile from the point of view of the radio communications network,

FIG. 5: this figure shows a diagram of the steps of a method for determining a movement of a mobile terminal in a second example of implementation,

FIG. 6: this figure shows a device capable of implementing certain steps of the solution described above.

### DETAILED DESCRIPTION OF THE EMBODIMENTS OF THE INVENTION

The general principle of the invention is based on the use of signalling data collected by a telecommunications operator operating at least one radio communication network to determine an (actual) move of a mobile terminal within the radio communication network, such as a distance actually travelled by the mobile terminal. More particularly, in the detailed embodiment, one of the signalling data used in the present solution may be a likelihood map of support by a base station. As explained above in the “description of the invention” section, such a likelihood map represents the probability of a mobile terminal connecting to a base station at a location within the coverage area of the base station. Thus, in at least some embodiments of the present method, the use of a likelihood map can help to improve the results obtained, compared with the solutions of the prior art, in terms of reliability, accuracy and/or realism.

Such knowledge can also help in a better classification of the different types of goods vehicles and their uses, enable a better management of the fleets of bicycles or scooters made available to the public, a better tracking of postal parcels equipped with connected trackers, etc.

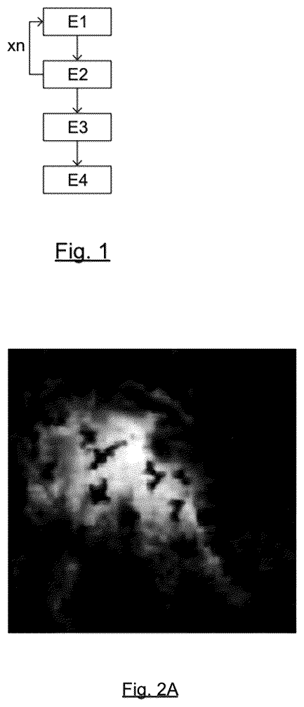

FIG. 1 shows a diagram of the steps of a method for determining a movement of a mobile terminal in a first example of implementation. In this first example, the variable representative of a movement of the mobile terminal is the distance actually travelled by a mobile terminal.

In a first phase, which can be implemented independently of the determining method, signalling data is collected, for example by means of probes placed in a radio communication network. This signalling data is then stored in one or more databases. In such a database, each entry corresponds, for example, to a network event.

In the detailed embodiments, the signalling data collected for a network event includes, but is not limited to:
a mobile terminal identifier (e.g. a pseudonym uniquely identifying the mobile terminal to the operator),
timestamp data for the occurrence of the network event,
an identifier for the base station or the cell that is associated with the network event.

In the detailed embodiments, enhanced signalling data can also be stored in the database. In this way, a network event can also be associated with a likelihood map of support by the cell associated with the base station with which the mobile terminal interacted during the occurrence of the event.

A likelihood map of support by at least one cell of a base station, with all the cells of a base station constituting the coverage area of the base station can, for example, be obtained by simulation. For example, for a base station comprising an antenna Aᵢ, a support likelihood map can represent a connection probability P(Aᵢ|(X,Y)∈pₖ) of the mobile terminal to the antenna Aᵢ where pₖ is one of the map's pixels, at the coordinate point (X, Y) knowing that the mobile terminal is located on the pixel pₖ.

Such a likelihood map of support by at least one cell of a base station is obtained from a geographical map representative of the coverage area of the base station and at least one assumption on an a priori presence of the mobile chosen, for example, from a uniform presence, a presence along main roads, and/or a presence as a function of population density, etc. Such a geographical map representative of the coverage area of the base station is obtained, for example, by simulations. The a priori presence of the mobile chosen may depend on the population of mobile terminals that are wanted to be monitored: an a priori presence of the mobile can be chosen when it is wanted to determine the distance travelled over the entire coverage area of the base station, an a priori presence along roads can be chosen if it is wanted to determine the distance travelled of mobile terminals onboard vehicles, an a priori presence can be chosen as a function of population density if it is wanted to monitor the movement of mobile terminals in residential areas.

Bayes formula is used to determine the probability that an event will occur knowing that another event has already occurred. Such a formula is written:

$$P ( {A}_{i} \vert ( X , Y ) ∈ {p}_{k} ) = \frac{P ( ( X , Y ) ∈ {p}_{k} ⋂ {A}_{i} )}{P ( ( X , Y ∈ {p}_{k} )} = \frac{P ( {A}_{i} ) P ( ( X , Y ) ∈ {p}_{k} \vert {A}_{i} )}{P ( ( X , Y ) ∈ {p}_{k} )}$$

This formula is used to express the probability of a mobile terminal connecting to the antenna Aᵢ of the base station knowing that it is located on the pixel pₖ

Since the geographic map representing the coverage area of the base station is partitioned into pixels, the total probability formula can thus be used to obtain the probability of a mobile terminal being located on the pixel pₖ knowing that it is connected to the antenna Aᵢ of the base station:

$$P ( ( X , Y ) ∈ {p}_{k} \vert {A}_{i} ) = \frac{P ( ( X , Y ) ∈ {p}_{k} ) P ( {A}_{i} \vert ( X , Y ) ∈ {p}_{k} )}{P ( {A}_{i} )} = \frac{P ( ( X , Y ) ∈ {p}_{k} ) P ( {A}_{i} \vert ( X , Y ) ∈ {p}_{k} )}{{\sum }_{{k}^{′}} P ( ( X , Y ) ∈ {p}_{{k}^{′}} ) P ( {A}_{i} \vert ( X , Y ) ∈ {p}_{{k}^{′}} )}$$

which is equivalent, by noting P((X,Y)∈pₖ)=Prior(k), to

$$P ( ( X , Y ) ∈ {p}_{k} \vert {A}_{i} ) = \frac{Prior ( k ) P ( {A}_{i} \vert ( X , Y ) ∈ {p}_{k} )}{{\sum }_{{k}^{′}} Prior ( {k}^{′} ) P ( {A}_{i} \vert ( X , Y ) ∈ {p}_{{k}^{′}} )} .$$

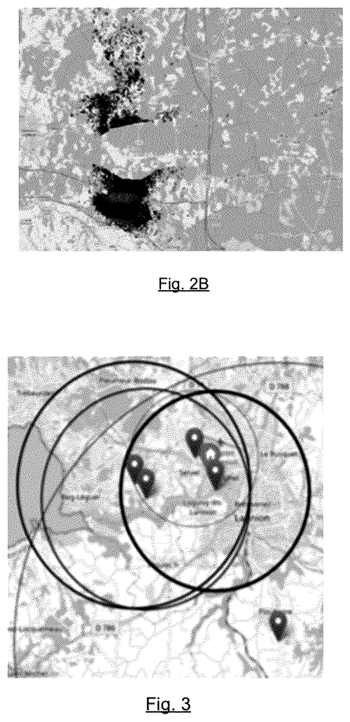

An example of such a likelihood map of support by a cell obtained with station obtained on the assumption of an a priori uniform presence of the mobile is shown in [FIG. 2A].

Another example of such a likelihood map of support by a cell obtained on the assumption of an a priori presence of the mobile along a road and a high-speed train line is shown in [FIG. 2B].

In some embodiments, an event can also be associated, in the database, with a value of a radius of action of an antenna of the corresponding base station, expressed in metres for example.

Thus, for each cell of a base station, it may be possible to define a radius of action R such that the probability of the presence of a mobile terminal in a disc of radius R around the centre of this cell, knowing the occurrence of a network event in this cell at a given time, is greater than or equal to a first probability (such as 85% in the detailed example).

The radius of action R may, for example, highly depend on the technology used (according to whether it complies with 2^{nd}, 3^{rd}, 4^{th} (LTE) or 5^{th} generation telecommunications standards) and/or the type of geographic area concerned, e.g. rural, urban or suburban.

In other words, for an antenna Aᵢ whose coordinates on the geographic map are (xᵢ,yᵢ), having a radius of action Rᵢ, and noting D_{R}_{ᵢ} the disc of radius Rᵢ centred on the centre of the cell in question, there is:

P ((X,Y)∈D_{R}_{ᵢ}|Aᵢ)≥85% noting (X,Y) the pair of random variables giving the position of the mobile terminal at time tᵢ.

FIG. 3 illustrates this notion of radius of action.

This method is based on the use of signalling data relating to mobile terminals, and therefore to their users. Also, in certain implementation modes, its use must comply with regulatory data anonymisation and/or pseudonymisation constraints. In addition, these constraints can sometimes impose (relatively short) deadlines for data anonymisation and/or pseudonymisation. In some embodiments, the calculations to be performed use signalling data whose history (i.e. conservation) must not exceed a certain duration. This duration, or time window, may be one or several tens of minutes depending on the design, for example 15 minutes.

In some embodiments, the method may comprise (in a first step E1) a selection of a first network event ER1 and of a second network event ER2 from a plurality of network events ERᵢ involving the mobile terminal. Such a selection consists in taking all the pairs of network events such that the two network events ER1 and ER2 constituting a pair of network events are present in the time window considered, that they are separated by a minimal duration, for example 5 minutes, and are such that the network event ER2 is later than the network event ER1.

The first and second network events ER1, ER2 occur respectively at times t₁ and t₂ and involve the antennas A₁ and A₂ carried by two base stations which may be different.

For i∈{1, 2} we denote (Xᵢ, Yᵢ) the random variables respectively giving the longitude and latitude of the mobile terminal at time tᵢ.

In the rest of the document, the following assumptions are made:
the random variables (Xᵢ,Yᵢ) associated with the probability densities of the presence of the two antennas A₁ and A₂ are independent,
the movement of the mobile terminal is assumed to be uniformly rectilinear if the time between two events is less than a first duration (for example a constant duration acting as a minimum threshold).

The steps E2 to E3 described below are implemented for two distinct sets of network events JER1 and JER2. The first set of network events JER1 comprises all the network events relating to the terminal over the duration of the time window considered (regardless of the base station to which they relate). The second set of network events JER2 comprises at least one set of at least two network events relating to the mobile terminal, all of which occur within a coverage area of the same base station. This second set of network events is used to determine an uncertainty of movement of the mobile terminal inherent in the average radio communication network. In other words, this uncertainty of movement of the mobile terminal inherent in the radio communication network can be assimilated to noise.

In a step E2, a distance density f_{D}_{₁₂} is determined for two network events ER1 and ER2 belonging to the first set of network events JER1. By using the total probability formula and the assumptions mentioned above, we can prove that the random variables (Xᵢ,Yᵢ) follow a density law fᵢ. Naturally, other calculation methods can be used to obtain the distance density f_{D}_{₁₂}.

It is then posed D₁₂=\sqrt{(X₂−X₁)²+(Y₂−Y₁)²} where D₁₂ is the random variable giving the distance travelled by the mobile terminal between the times t₁ and t₂.

The random variable D₁₂ follows a density law f_{D}_{₁₂} such that: ∀d∈ [symbol] ₊:

$${f}_{{D}_{12}} ( d ) = {\int }_{{ℝ}^{3}} {f}_{1} ( {x}_{1} , {y}_{1} ) {\sum }_{\pm } {f}_{2} ( {x}_{2} , {y}_{1} \pm \sqrt{{d}^{2} - {( {x}_{2} - {x}_{1} )}^{2}} ) \frac{d {\{ d > \vert {x}_{2} - {x}_{1} \vert \}}_{} ( {x}_{1} , {x}_{2} , d )}{\sqrt{{d}^{2} - {( {x}_{2} - {x}_{1} )}^{2}}} {dx}_{1} {dx}_{2} {dy}_{1} \qquad ( 1 )$$

By integrating this density over a distance interval [dₐ,d_{b}] included in [symbol] ₊ and noting E(dₐ,d_{b})={(x,y,x′,y′)∈ [symbol] ⁴/|y′−y|≤\sqrt{d_{b}²−(x′−x)²} et dₐ≤|x′−x|≤d_{b}}, it is obtained, after inversion and with the help of changes of variables y₂=y₁±\sqrt{d²−(x₂−x₁)²} in the appropriate integrals, we obtain a form that is much more convenient for numerical calculation:

$${\int }_{{d}_{a}}^{{d}_{b}} {f}_{{D}_{12}} ( d ) = {\int }_{{ℝ}^{4}} {f}_{1} ( {x}_{1} , {y}_{1} ) {f}_{2} ( {x}_{2} , {y}_{2} ) {E ( {d}_{a} , {d}_{b} )}_{} ( {x}_{1} , {x}_{2} , {y}_{1} , {y}_{2} ) {dx}_{1} {dx}_{2} {dy}_{1} {dy}_{2} \qquad ( 2 )$$

A method of calculating this distance density f_{D}_{₁₂} can, in some embodiments, involve creating a spatial mesh of the two geographical maps representative of a coverage zone of a base station associated with an antenna Aᵢ, a first geographical map corresponding to the base station involved in the network event ER1 and a second geographical map corresponding to the base station involved in the network event ER2. Each pixel pₖ of this mesh is associated with a support probability by the antenna Aᵢ conditioned by the presence of the mobile terminal at this pixel P(Aᵢ|(X,Y)∈pₖ). Such information is provided by the likelihood map of support by a cell associated with the antenna Aᵢ.

The same operations can be applied to a second pair of network events ER3 and ER4 belonging to the second set of network events JER2, which both occur within a coverage area of the same base station, in order to obtain a density of a distance f_{D}_{₃₄} travelled for the pair of network events ER3, ER4.

Hence, in some embodiments, at the end of a step E2 a first distance density f_{D}_{₁₂} travelled for the pair of events ER1, ER2 and a second distance density f_{D}_{₃₄} travelled for the pair of network events ER3, ER4 can be obtained.

This second distance density f_{D}_{₃₄} travelled represents an uncertainty of movement of the mobile terminal inherent in the radio communication network, which will make it possible to determine whether the first distance density f_{D}_{₁₂} travelled corresponds to an (actual) movement of the mobile terminal or corresponds to an immobile mobile terminal from the point of view of the radio communications network, that is a mobile terminal that has remained within the coverage area of the same base station.

To improve the accuracy of the value of the distance travelled by the mobile terminal, and the accuracy of the value of the uncertainty of movement of the mobile terminal inherent in the radio communication network, steps E1 and E2 can be repeated, in certain embodiments, for a plurality of pairs of network events belonging to the first set of network events JER1 and/or for a plurality of pairs of network events belonging to the second set of network events JER2 (on the condition, for example, that the times tᵢ associated with each of the events are comprised within the time window (of 15 minutes, for example) defined above). Naturally, the length of the time window can take on any other value according to embodiments (for example, depending on requirements, legislation, etc.)

Thus, once all the pairs of events ERᵢ, ERⱼ taken within the time window have been constituted for the two sets of network events JER1 and JER2, steps E1 and E2 can be implemented for pairs of events ERᵢ, ERⱼ from one of these two sets of network events JER1 and JER2 (for each of these pairs from these two sets, for example). At the end of these various iterations of steps E1 and E2, it is possible to obtain, for the first set of network events JER1, as many distances densities travelled by the mobile terminal as there are pairs of events ERᵢ, ERⱼ originating from this set of network events JER1 and, for the second set of network events JER2, as many values of an uncertainty of movement of the mobile terminal inherent in the radio communication network as there are pairs of events ERᵢ, ERⱼ originating from this set of network events JER2.

In some embodiments, the method may comprise (in a step E3) a combination between them of the different travelled distance densities of the mobile terminal obtained for the pairs of network events belonging to the first set of network events JER1. Such a combination may, for example, result in an average travelled distance density of the mobile terminal for a duration less than or equal to that of the time window considered.

Such embodiments may, for example, be based on an additional assumption. Hence, it can be assumed that there is a distance travelled law relating to the movement of the mobile terminal. For example, it can be assumed that this distance travelled law relating to the movement of the mobile terminal can be obtained from the different distance travelled densities of the mobile terminal corresponding to the pairs of events ERᵢ, ERⱼ.

In the detailed embodiments, in order to obtain the density of the average movement distance travelled density of the mobile terminal over the duration of the time window considered, it is possible, for example, to consider two pairs of events belonging to the first set of network events JER1, a first pair of events C₁ constituted by events ER1 and ER2 and a second pair of events C₂ constituted by events ER5 and ER6, as well as the corresponding movement distance travelled densities of the mobile terminal obtained at the end of the implementation of steps E1 and E2, and noted respectively D₁ and D₂.

Note D the random variable representing the average movement distance travelled density of the mobile terminal, which is sought to be obtained from the movement distance travelled densities of the mobile terminal D₁ and D₂.

Knowing the following property:

$$∀ ( d , {d}^{′} ) ∈ {ℝ}_{+}^{2} , P ( D ∈ [ d , {d}^{′} ] ) > 0 ⇔ P ( {D}_{1} ∈ [ d , {d}^{′} ] ) > 0 ) \text{} et P ( {D}_{2} ∈ [ d , {d}^{′} ] ) > 0 ) \qquad ( 3 )$$

which says that for the event, in the sense of probabilities, “D∈[d, d′]” occurs with a non-null probability, it is necessary and sufficient that the events, in the sense of probabilities, “Dᵢ∈[d, d′]” occur with a non-null probability.

By noting that the distance travelled densities of the mobile terminal VD₁ and D₂ are independent of each other by construction, property (3) can then be rewritten as:

$$∀ ( d , {d}^{′} ) ∈ {ℝ}_{+}^{2} , P ( D ∈ [ d , {d}^{′} ] ) > 0 ⇔ P ( {D}_{1} > 0 ⋂ {D}_{2} > 0 ) > 0 \qquad ( {3}^{′} )$$

If we consider the average distance travelled density of the mobile terminal D verifying equation (3′) as the result of two random experiments whose order does not matter, it is then possible to write, by noting I_{d,d′}=[d, d′] for all d, d′:

$$( D ∈ {I}_{d , {d}^{′}} ) = P ( {D}_{1} , {D}_{2} ∈ {I}_{d , {d}^{′}}^{2} ) + P ( {D}_{1} ∉ {I}_{d , {d}^{′}} ⋂ {D}_{2} ∈ {I}_{d , {d}^{′}} ) {\{ P ( {D}_{1} ∈ {I}_{d , {d}^{′}} ) > 0 \}}_{} ( d , {d}^{′} ) + P ( {D}_{1} ∈ {I}_{d , {d}^{′}} ⋂ {D}_{2} ∉ {I}_{d , {d}^{′}} ) {\{ P ( {D}_{1} ∈ {I}_{d , {d}^{′}} ) > 0 \}}_{} ( d , {d}^{′} )$$

which can be rewritten, thanks to the independence of the two distance densities travelled by the mobile terminal D₁ and D₂, in the form:

$$P ( D ∈ {I}_{d , {d}^{′}} ) = ( 1 - P ( {D}_{1} ∉ {I}_{d , {d}^{′}} ) P ( {D}_{2} ∉ {I}_{d , {d}^{′}} ) ) {\{ P ( {D}_{1} ∈ {I}_{d , {d}^{′}} ⋂ {D}_{2} ∈ {I}_{d , {d}^{′}} ) > 0 \}}_{} ( d , {d}^{′} ) \qquad ( 4 )$$

Such an expression can easily be generalised to n independent distance densities travelled by the mobile terminal, where n corresponds to the number of event pairs C constituted for a given time window.

Equation (4) can then be normalised to verify the following property:

P(V∈ [symbol] ₊)=1 which means that the average distance travelled by the mobile terminal being searched for is positive or null.

The same reasoning can be applied to obtain a combination between them of the different values of an uncertainty of movement of the mobile terminal inherent in the radio communication network obtained for the pairs of network events belonging to the second set of network events JER2.

As previously, two pairs of events are considered, belonging to the second set of network events JER2, a first pair of events C₃ constituted by events ER3 and ER4 and a second pair of events C₄ constituted by events ER7 and ER8, as well as the corresponding movement distance travelled densities of the mobile terminal obtained at the end of the implementation of steps E1 and E2, and noted respectively D₃ and D₄. A random variable D′ is then obtained representing an uncertainty of movement of the mobile terminal inherent in the average radio communication network.

In some embodiments, it is possible, for example, to compare the first density of distance travelled by the mobile terminal, obtained from pairs of events belonging to the first set of network events JER1, with this noise information, obtained from pairs of events belonging to the second set of network events JER2, in order to determine whether the mobile terminal has actually moved, i.e. has changed its home base station consecutively to an (actual) move, or whether the mobile terminal has not left the coverage area of a base station and is therefore immobile from the point of view of the radio communications network.

In some embodiments, in order to compare the first density of distance travelled and the second density of distance travelled, a Hellinger distance, for example, is determined in a step E4. Such a Hellinger distance can be constructed from a Bhattacharyya coefficient.

As explained in more detail below, the value of the Hellinger distance constructed in this way is used to determine whether the mobile terminal has actually moved. When the Hellinger distance has a high value, that is when it is close to 1, the mobile terminal is considered to have actually moved. When the Hellinger distance has a low value, that is when it is close to 0, the mobile terminal is considered to be immobile. Thus, for continuous probability densities p and q, the Bhattacharyya coefficient is defined as: BC(p, q)=∫\sqrt{p(x)q(x)}dx.

Such a Bhattacharyya coefficient lies between 0, where the continuous probability densities p and q do not overlap, and 1, where the continuous probability densities p and q are equal.

The Hellinger distance is then defined as: d_{H}(p, q)=\sqrt{1−BC(p,q)}.

This distance also lies between 0, where the continuous probability densities p and q do not overlap, and 1, where the continuous probability densities p and q are equal.

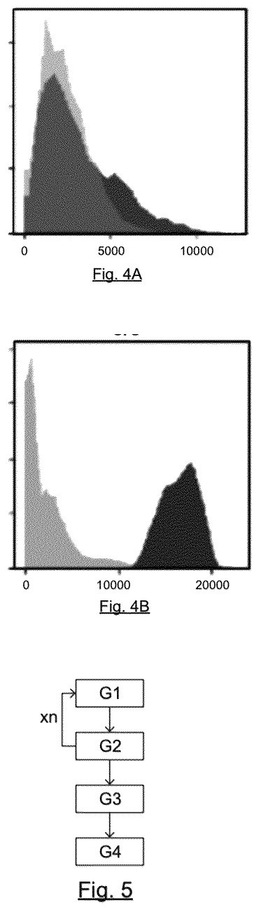

FIG. 4A and FIG. 4B respectively show a situation in which the mobile terminal is immobile from the point of view of the radio communications network and a situation in which the mobile terminal is mobile from the point of view of the radio communications network.

FIG. A4 indeed shows that the two densities of distance travelled overlap almost completely, corresponding to a Hellinger distance close to 0. In FIG. 4B, on the other hand, it is seen that the two densities of distance travelled do not overlap, corresponding to a Hellinger distance close to 1.

In some embodiments, to mitigate the phenomenon of network oscillation, the times tᵢ and tⱼ corresponding respectively to a network event ERᵢ and to an event ERⱼ constituting a pair Cᵢ of network events, can be chosen to be separated by a minimum duration. This means that the time elapsed between the occurrence of the event ERᵢ and the event ERⱼ is greater than or equal to a first duration. Such a duration, acting as a threshold, can for example, when the time window considered lasts 15 minutes, be set in the order of a few minutes (for example 3 to 9 minutes), such as a duration of 6 minutes. Naturally, other values of this first duration can be envisaged.

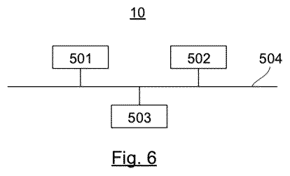

FIG. 5 shows a diagram of the steps of a method for determining a movement of a mobile terminal in a second example of implementation. In this second example, the variable representative of a movement of the mobile terminal is the movement direction.

This method relying on the use of signalling data relating to mobile terminals, and therefore to their users, its implementation may comply with constraints on anonymisation, or pseudoanonymisation, in the short term. Hence, the calculations to be performed use for example signalling data whose history does not exceed a certain duration. Such as duration is 15 minutes, for example.

In some embodiments, the method may comprise (in a first step G1) a selection of a first network event ER1 and of a second network event ER2 from a plurality of network events ER, involving the mobile terminal. Such a selection consists in taking all the pairs of network events such that the two network events ER1 and ER2 constituting a pair of network events are present in the time window considered, that they are separated by a minimal duration, for example 5 minutes, and are such that the network event ER2 is later than the network event ER1.

The steps G2 to G3 described below are implemented for two distinct sets of network events JER1 and JER2. The first set of network events JER1 comprises all the network events relating to the terminal over the duration of the time window considered (regardless of the base station to which they relate). The second set of network events JER2 comprises one set of network events relating to the mobile terminal, all of which occur within a coverage area of the same base station. This second set of network events is used to determine an uncertainty of movement direction of the mobile terminal inherent in the average radio communication network. In other words, this uncertainty of movement of the mobile terminal inherent in the radio communication network can be assimilated to noise.

In a step G2, a direction density f_{θ}_{₁₂} is determined for two network events ER1 and ER2 belonging to the first set of network events JER1. By using the total probability formula and the assumptions mentioned above, we can prove that the random variables (Xᵢ,Yᵢ) follow a density law fᵢ. Naturally, other calculation methods can be used to obtain the direction density f_{θ}_{₁₂}.

It is then posed

$${θ}_{12} = arctan ( \frac{{Y}_{2} - {Y}_{1}}{{X}_{2} - {X}_{1}} )$$

where θ₁₂ is the random variable giving the movement direction of the mobile terminal between the times t₁ and t₂.

The random variable θ₁₂ follows a density law f_{θ}_{₁₂}, such that: ∀θ∈[0, 2π[:

$${f}_{{θ}_{12}} ( θ ) = {\int }_{{ℝ}^{3}} {f}_{1} ( {x}_{1} , {y}_{1} ) {f}_{2} ( {x}_{2} , {y}_{1} + ( {x}_{2} - {x}_{1} ) tan ( θ ) ) \text{} ( {x}_{2} - {x}_{1} ) ( 1 + {tan}^{2} ( θ ) ) {\{ {x}_{2} \neq {x}_{1} \}}_{} {\{ θ \neq ( k + \frac{1}{2} ) π , k ϵ ℤ \}}_{} {dx}_{1} {dx}_{2} {dy}_{1}$$

Since the mobile terminal is assumed to move in a uniform rectilinear motion, a direction density is calculated as follows:

By integrating this density over an angle interval [θₐ,θ_{b}] included in

$$[ 0 , 2 π [ \backslash \{ ( k + \frac{1}{2} ) π , k ϵ ℤ \} ,$$

and noting
E(θₐ,θ_{b})={(x, y,x′,y′)∈ [symbol] ⁴. y′∈[y+(x′−x)tan(θₐ), (x′−x)tan(θ_{b})]}, it is obtained, after inversion and by means of the changes of variables y₂=y₁+(x₂−x₁)tan(θ) in the appropriate integrals, a form that is much more convenient for numerical calculation:

$${\int }_{{θ}_{a}}^{{θ}_{b}} {f}_{{θ}_{12}} ( θ ) d θ = {\int }_{{ℝ}^{4}} {f}_{1} ( {x}_{1} , {y}_{1} ) {f}_{2} ( {x}_{2} , {y}_{2} ) {E ( {θ}_{a} , {θ}_{b} )}_{} ( {x}_{1} , {x}_{2} , {y}_{1} , {y}_{2} ) {dx}_{1} {dx}_{2} {dy}_{1} {dy}_{2} \qquad ( 2 )$$

Thus, at the end of a step G2, a direction density f_{θ}_{₁₂} is obtained for a pair of network events ER1, ER2.

A method of calculating this direction density f_{θ}_{₁₂} can, in some embodiments, involve creating a spatial mesh of the two geographical maps representative of a coverage zone of a base station associated with an antenna Aᵢ, a first geographical map corresponding to the base station involved in the network event ER1 and a second geographical map corresponding to the base station involved in the network event ER2. Each pixel pₖ of this mesh is associated with a support probability by the antenna Aᵢ conditioned by the presence of the mobile terminal at this pixel P(Aᵢ|(X,Y)∈pₖ). Such information is provided by the likelihood map of support by a cell associated with the antenna Aᵢ.

The same operations can be applied to a second pair of network events ER3 and ER4 belonging to the second set of network events JER2 in order to obtain a distance density f_{θ}_{₃₄} covered for the pair of network events ER3, ER4.

Hence, in some embodiments, at the end of a step G2, a first direction density f_{θ}_{₁₂} for the pair of events ER1, ER2 and a second direction density f_{θ}_{₃₄} for the pair of network events ER3, ER4 can be obtained.

This second direction density f_{θ}_{₃₄}, taken represents an uncertainty of movement of the mobile terminal inherent in the radio communication network, which will make it possible to determine whether the first direction density f_{θ}_{₁₂} corresponds to an (actual) movement of the mobile terminal or corresponds to an immobile mobile terminal from the point of view of the radio communications network, that is a mobile terminal that has remained within the coverage area of the same base station.

To improve the accuracy of the value of the direction taken by the mobile terminal, and the accuracy of the value of the uncertainty of movement of the mobile terminal inherent in the radio communication network, steps G1 and G2 can be repeated, in certain embodiments, for a plurality of pairs of network events belonging to the first set of network events JER1 and/or for a plurality of pairs of network events belonging to the second set of network events JER2 (on the condition, for example, that the times tᵢ associated with each of the events are comprised within the time window of 15 minutes defined above). Naturally, the length of the time window can take on any other value according to embodiments (for example, depending on requirements, legislation, etc.)

Thus, once all the pairs of events ERᵢ, ERⱼ taken within the time window have been constituted for the two sets of network events JER1 and JER2, steps G1 and G2 can be implemented for pairs of events ERᵢ, ERⱼ from one of these two sets of network events JER1 and JER2 (for each of these pairs from these two sets, for example). At the end of these various iterations of steps G1 and G2, it is possible to obtain, for the first set of network events JER1, as many direction densities of the mobile terminal as there are pairs of events ERᵢ, ERⱼ originating from this set of network events JER1 and, for the second set of network events JER2, as many values of an uncertainty of movement direction of the mobile terminal inherent in the radio communication network as there are pairs of events ERᵢ, ERⱼ originating from this set of network events JER2.

In some embodiments, the method may comprise (in a step G3) a combination between them of the different direction densities of the mobile terminal obtained for the pairs of network events belonging to the first set of network events JER1. Such a combination may, for example, result in a average direction density taken by the mobile terminal for a duration less than or equal to that of the time window considered.

Such embodiments may, for example, be based on an additional assumption. Hence, it can be assumed that there is a direction law relating to the movement of the mobile terminal. For example, it can be assumed that this direction law relating to the movement of the mobile terminal can be obtained from the different direction densities of the mobile terminal corresponding to the pairs of events ERᵢ, ERⱼ.

In the detailed embodiments, to obtain the density of the average movement direction density of the mobile terminal over the duration of the time window considered, it is possible, for example, to consider two pairs of events belonging to the first set of network events JER1, a first pair of events C₁ constituted by events ER1 and ER2 and a second pair of events C₂ constituted by events ER5 and ER6, as well as the corresponding densities of direction taken by the mobile terminal obtained at the end of the implementation of steps G1 and G2, and noted respectively θ₁ and θ₂.

Note θ the random variable representing the average movement direction density of the mobile terminal, which it is sought to be obtained from the movement direction densities of the mobile terminal θ₁ and θ₂.

Knowing the following property:

$$∀ ( θ , {θ}^{′} ) ∈ [ 0 , 2 π {[}^{2} , P ( θ ∈ [ θ , {θ}^{′} ] ) > 0 ⇔ P ( {θ}_{1} ∈ [ θ , {θ}^{′} ] ) > 0 ) \text{} et P ( {θ}_{2} ∈ [ θ , {θ}^{′} ] ) > 0 ) \qquad ( 3 )$$

which says that for the event, in the sense of probabilities, “θ∈[θ,θ′]” occurs with a non-null probability, it is necessary and sufficient that the events, in the sense of probabilities, “θᵢ∈[θ,θ′]” occur with a non-null probability.

By noting that the movement direction densities of the mobile terminal θ₁ and θ₂ are independent of each other by construction, property (3) can then be rewritten as:

$$∀ ( θ , {θ}^{′} ) ∈ [ 0 , 2 π {[}^{2} , P ( θ ∈ [ θ , {θ}^{′} ] ) > 0 ⇔ P ( {θ}_{1} > 0 ⋂ {θ}_{2} > 0 ) > 0 \qquad ( {3}^{′} )$$

If we consider the average direction density of the mobile terminal θ verifying equation (3′) as the result of two random experiments whose order does not matter, it is then possible to write, by noting I_{θ,θ′}+=[θ,θ′] for all θ,θ′:

$$P ( θ ∈ {I}_{θ , {θ}^{′}} ) = P ( {θ}_{1} , {θ}_{2} ∈ {1}_{θ , {θ}^{′}}^{2} ) + P ( {θ}_{1} ∉ {I}_{θ , {θ}^{′}} ⋂ {θ}_{2} ∈ {I}_{θ , {θ}^{′}} ) {\{ P ( {θ}_{1} ∈ {I}_{θ , {θ}^{′}} ) > 0 \}}_{} ( θ , {θ}^{′} ) + P ( {θ}_{1} ∉ {I}_{θ , {θ}^{′}} ⋂ {θ}_{2} ∉ {I}_{θ , {θ}^{′}} ) {\{ P ( {θ}_{2} ∈ {I}_{θ , {θ}^{′}} ) > 0 \}}_{} ( θ , {θ}^{′} )$$

which can be rewritten, thanks to the independence of the two movement direction densities of the mobile terminal θ₁ and θ₂, in the form:

$$P ( θ ∈ {I}_{θ , {θ}^{′}} ) = ( 1 - P ( {θ}_{1} ∉ {I}_{θ , {θ}^{′}} ) P ( {θ}_{2} ∉ {1}_{θ , {θ}^{′}} ) P ( {θ}_{2} ∉ {I}_{θ , {θ}^{′}} ) ) {\{ P ( {θ}_{1} ∈ {I}_{θ , {θ}^{′} ,} ) > 0 \}}_{} ( θ , {θ}^{′} ) \qquad ( 4 )$$

Such an expression can easily be generalised to n independent mobile terminal movement direction densities, where n corresponds to the number of event pairs C constituted for a given time window.

In some embodiments, equation (4) can then be normalised to verify the following property:

P(θ∈[0, 2π[)=1, which means that the average movement direction of the mobile terminal being searched for is in the interval [0, 2π[.

In some embodiments, from the average movement direction density of the mobile terminal thus determined, it is possible to obtain, in a step G4, a value of an average movement direction of the mobile terminal by calculating the expectation of a probability law associated with the average movement direction density of the mobile terminal θ.

Insofar as the direction densities of the mobile terminal are circular densities, the calculation of the expectation and standard deviation must be adapted.

To do this, it is necessary to set: m₁=∫_{Γ} P(θ)e^{iθ} dθ, where Γ is any interval of range 2π.

The average movement direction of the mobile terminal is then expressed as θ̅=arg(m₁).

There are several possible methods for calculating the standard deviation, most often using the modulus of m₁ and an analogy with a circular normal distribution. In an example, the following estimator of the standard deviation is given by:

$${σ}_{θ} = arcsin ( ε ) [ 1 + ( \frac{2}{\sqrt{3}} - 1 ) {ε}^{3} ] ,$$

where ∈={square root over (1−(Re(m₁)²+Im(m₁)²))} where Re(m1) and Im(m1) denote the real part and imaginary part of m1 respectively. This standard deviation is then used to determine a 95% confidence interval.

The same reasoning can be applied to obtain a combination between them of the different values of an uncertainty of movement of the mobile terminal inherent in the radio communication network obtained for the pairs of network events belonging to the second set of network events JER2.

As previously, two pairs of events are considered, belonging to the second set of network events JER2, a first pair of events C₃ constituted by events ER3 and ER4 and a second pair of events C₄ constituted by events ER7 and ER8, as well as the corresponding movement direction densities the mobile terminal obtained at the end of the implementation of steps G1 and G2, and noted respectively θ₃ and θ₄. A random variable θ′ is then obtained representing an uncertainty of movement direction of the mobile terminal inherent in the average radio communication network.

FIG. 6 illustrates a device 10 capable of implementing certain steps of the previously described solution.

A device 10 may comprise at least one hardware processor 501 correspond to the processor μPr of FIG. 1, a storage unit 502 and an interface 503, which are connected to each other via a bus 504. Naturally, the components of the device 10 can be connected by means of a connection other than a bus.

The processor 501 controls the operations of the device 10. The storage unit 502 stores at least one program for implementing the various methods that are the subject of the invention to be executed by the processor 501, and various data, such as parameters used for calculations performed by the processor 501, intermediate data for calculations performed by the processor 501, etc. The processor 501 may be formed by any known and appropriate hardware or software, or by a combination of hardware and software. For example, the processor 601 can be formed by a dedicated hardware such as a processing circuit, or by a programmable processing unit such as a Central Processing Unit which executes a program stored in a memory thereof.

The storage unit 502 may be formed by any appropriate means capable of storing the program or programs and data in a computer-readable manner. Examples of storage devices 502 include non-transitory computer-readable storage media such as semiconductor memory devices, and magnetic, optical or magneto-optical recording media loaded into a read/write device.

Interface 503 provides an interface between device 10 and other equipment in the radio communication network.

1. A method implemented by a device and comprising:
obtaining a value of a variable representative of a movement of a mobile terminal from:
a first probability density of said variable representative of a movement of the mobile terminal according to:
first connection probabilities of said terminal on a first coverage area of a first base station with which the mobile terminal interacted during a first timestamped network event involving said mobile terminal, and
second connection probabilities of said terminal on a second coverage area of a second base station with which the mobile terminal interacted during a second timestamped network event involving said mobile terminal, and
a second probability density of said variable representative of a movement of the mobile terminal, obtained by using third connection probabilities of said terminal within a third coverage area of a third base station with which the mobile terminal interacted during a third network event involving the mobile terminal, and a fourth network event involving the mobile terminal.

2. (canceled)

3. The method according to claim 1 wherein said first, second, third and/or fourth network event is associated respectively with a first, second, third and/or fourth set of signalling data comprising, among others, respectively, an item of timestamp data of said first, second, third and/or fourth network event.

4. The method according to claim 1 wherein obtaining said value representative of a variable representative of a movement of the mobile terminal comprises a comparison between the first probability density of said variable representative of a movement of the mobile terminal and the second probability density of said variable representative of a movement of the mobile terminal.

5. The method according to claim 4 wherein the comparison between the first probability density of said variable representative of a movement of the mobile terminal and the second probability density of said variable representative of a movement of the mobile terminal comprises determining an overlap rate between the first probability density of a variable representative of a movement of the mobile terminal and the second probability density of said variable representative of a movement of the mobile terminal.

6. The method according to claim 1 wherein the first event and the second event are selected from a plurality of network events involving the mobile terminal, occurred during a first time window.

7. The method according claim 1 comprising at least two iterations of the obtaining and further comprises determining an average value of said variable representative of a movement of the mobile terminal by combining the first probability densities of said variable representative of a movement of the mobile terminal determined during each of said iterations.

8. The method according to claim 1 wherein the first event and the second event are temporally spaced by at least one first duration.

9. The method according to claim 1 wherein said variable representative of a movement of a mobile terminal is a movement distance of the mobile terminal.

10. The method according to claim 1 wherein the variable representative of a movement of a mobile terminal is a movement direction of the mobile terminal.

11. A device capable of determining a movement of a mobile terminal, said device comprising:
at least one processor adapted to obtain a value of a variable representative of a movement of a mobile terminal from:
a first probability density of said variable representative of a movement of the mobile terminal according to:
first connection probabilities of said terminal on a first coverage area of a first base station with which the mobile terminal interacted during a first timestamped network event involving said mobile terminal, and
second connection probabilities of said terminal on a second coverage area of a second base station with which the mobile terminal interacted during a second timestamped network event involving said mobile terminal,
and a second probability density of said variable representative of a movement of the mobile terminal, obtained by using third connection probabilities of said terminal within a third coverage area of a third base station with which the mobile terminal interacted during a third network event involving the mobile terminal, and a fourth network event involving the mobile terminal.

12. A non-transitory computer readable medium comprising a computer program product stored thereon comprising program code instructions for implementing a method, when the program is executed by a processor, the method comprising:
obtaining a value of a variable representative of a movement of a mobile terminal from:
a first probability density of said variable representative of a movement of the mobile terminal according to:
first connection probabilities of said terminal on a first coverage area of a first base station with which the mobile terminal interacted during a first timestamped network event involving said mobile terminal, and
second connection probabilities of said terminal on a second coverage area of a second base station with which the mobile terminal interacted during a second timestamped network event involving said mobile terminal,
and a second probability density of said variable representative of a movement of the mobile terminal, obtained by using third connection probabilities of said terminal within a third coverage area of a third base station with which the mobile terminal interacted during a third network event involving the mobile terminal, and a fourth network event involving the mobile terminal.

13. The device according to claim 11 wherein said first, second, third and/or fourth network event is associated respectively with a first, second, third and/or fourth set of signalling data comprising, among others, respectively, an item of timestamp data of said first, second, third and/or fourth network event.

14. The device according to claim 11 wherein obtaining said value representative of a variable representative of a movement of the mobile terminal comprises a comparison between the first probability density of said variable representative of a movement of the mobile terminal and the second probability density of said variable representative of a movement of the mobile terminal.

15. The device according to claim 14 wherein the comparison between the first probability density of said variable representative of a movement of the mobile terminal and the second probability density of said variable representative of a movement of the mobile terminal comprises determining an overlap rate between the first probability density of a variable representative of a movement of the mobile terminal and the second probability density of said variable representative of a movement of the mobile terminal.

16. The device according to claim 11 wherein the first event and the second event are selected from a plurality of network events involving the mobile terminal, occurred during a first time window.

17. The device according to claim 11 comprising at least two iterations of the obtaining and further comprises determining an average value of said variable representative of a movement of the mobile terminal by combining the first probability densities of said variable representative of a movement of the mobile terminal determined during each of said iterations.

18. The device according to claim 11 wherein the first event and the second event are temporally spaced by at least one first duration.

19. The device according to claim 11 wherein said variable representative of a movement of a mobile terminal is a movement distance of the mobile terminal.
